(19) United States
(12) Patent Application Publication
(10) Pub. No.: US 2026/0028096 A1
(43) Pub. Date: Jan. 29, 2026

(54) Surfboard for Wave Pools

(71) Applicant: Continental Link Composite PTE. LTD., Singapore (SG)

(72) Inventor: Trent Pedersen, Samutprakarn (TH)

(73) Assignee: Continental Link Composite PTE. LTD., Singapore (SG)

(21) Appl. No.: 19/278,200

(22) Filed: Jul. 23, 2025

Related U.S. Application Data
(60) Provisional application No. 63/674,479, filed on Jul. 23, 2024.

(51) Int. Cl. B63B 32/59; B32B 5/20; B32B 27/06; B32B 27/28; B32B 27/30; B32B 27/38; B63B 32/50; B63B 32/57

(52) U.S. Cl. CPC B63B 32/59; B32B 5/20; B32B 27/065; B32B 27/28; B32B 27/302; B32B 27/38; B63B 32/50; B63B 32/57; B32B 2266/0271

(57) ABSTRACT

A wave pool surfboard has a complex but effective method of manufacture. An EPS blank is molded to the approximate shape, then sanded to a final shape. A variety of strengthening materials, including ABS and several types of fiberglass, are laid down upon the top, bottom, and rails (sides) of the board, then attached to the blank with epoxy foam, which is applied with a spray gun. Special protection is given to the nose, tail, and rails of the surfboard, as these are the most commonly damaged parts in a wave pool environment. Fin boxes are installed, and then the surfboard is placed into a vacuum mold where it is fused to a pre-thermoformed ABS sheet (by heat and vacuum) which becomes the protective surface of the board. The surfboard is removed from the mold, trimmed, rail laminated, rail puttied and sanded, painted, pin-lined and finished with a UV-stable clearcoat.

### CROSS REFERENCE TO RELATED APPLICATIONS

This application claims priority back to U.S. Provisional No. 63/674,479, filed Jul. 23, 2024, the contents of which are incorporated by reference into this utility patent application.

### STATEMENT REGARDING FEDERALLY SPONSORED RESEARCH OR DEVELOPMENT

This invention was not federally sponsored.

### Field of the Invention

This disclosure is directed generally to surfboards, and more specifically to a surfboard specifically made for the unusual requirements of wave pools.

### Background of the Invention

Surfing has been a popular sport since the 1950's and 1960's. At that time, surfing was confined to the ocean, and those who lived “inland” of the ocean, had to either drive to the ocean to surf or find another sport that interested them. If you were a teenager living in Kansas, a 4-day drive to the beach and back for a surf session was not a realistic option. Over the years, a subset of surfers began surfing river waves, caused by water flowing over a rock or other obstruction, and some began surfing in fresh-water lakes. However, fresh-water lakes only have good waves when there is the right combination of wind in the right direction for the right amount of time, and river waves are not common, and in some cases, not easily accessible. This created an opportunity for wave pools and standing waves to be created, where surfable waves could be created wherever there was a wave pool. As for this writing, there are wave pools and standing waves built or being built on six continents and there are even wave pool magazines specifically devoted to wave pools. Because wave pools can be built indoors (i.e. West Edmonton Mall Surf Club), they can provide year-round surfing in even the harshest climates.

The Problem with Wave Pools. Wave pools generate a consistent and more aggressive wave environment compared to a natural beach with ocean waves due to a rapid and repetitive wave supply and material design. The nose, fins, rails and tail of surfboards are particularly prone to impact damage due to this high repetition and impact with the concrete walls and floor. In addition, the pool environment has metal rails, stairs, and slippery walkways, it is much easier (and more common) for surfers to damage their surfboards at a wave pool than at the average surfing beach. The innovative construction method used in manufacturing this invention creates a superior durability as well as strategically reinforcing susceptible areas significantly enhancing their resistance to breakage, dings, cracks, and other forms of damage while maintaining desirable weights and performance characteristics.

The design of the wave pool facility itself creates additional dangers of damage to surfboards. Because the wave pool generates consistent waves, a wave pool surfer may ride over 20 high quality waves in an hour. In the ocean environment, on the other hand, a surfer may have to wait 10 to 20 minutes between “sets” of waves, and in a crowded surf spot, the surfer is not going to catch a wave with every set. Therefore, a surfboard used in a wave pool can easily get 10× or more the “use” of a surfboard used in an ocean environment over a given amount of time.

Wave pools also have shallow depths relative to ocean waves, and often the waves are made intentionally “steep”, such that there is a greater chance of the board impacting the wave pool bottom in the event of a wipeout. So, it is a concentration of waves, their form and frequency combined with shallow water depths and concrete that places an artificial demand upon equipment that traditional surfboards are simply not constructed to withstand. A regular surfboard may withstand the rigors of surfing 10-15 waves in a day, on a sandy beach with a sand bottom, but that same surfboard cannot stand up to riding several hundred waves per day under the feet of a variety of riders with different skills and weights in a concrete environment. This manufacturing technology was created to solve this problem.

Commercial wave pool operators require fleets of boards to provide to users, the more these boards are out in the water being rented and the less the boards are out of commission being repaired, the more profit the owner will make. With the current fleets of boards used at wave pools, they are very frequently out of commission due to damage which not only costs money to repair but also highly impacts satisfaction ratings by users who often bear the costs of these repairs. This invention provides an incredibly durable, high-performance surfboard which is enjoyable to ride and due to the low amounts of damage creates a higher ROI for operators via lower costs and more happy/repeat customers.

Traditional surfboards are built using hand shaping and lamination with lower quality polyurethane foams and polyester resins. This is adequate for natural surf breaks where the conditions are highly variable and receive much lower amounts of contact with hard surfaces. This invention, on the other hand, is specifically engineered for the far greater demands of this concentrated, repetitive and harsh wave pool environment where each surfer will ride as many waves as humanly possible in a condensed time period.

### Brief Summary of the Invention

The invention disclosed in this document describes a surfboard that is specifically manufactured for wave pools and built to survive the extra abuse and demands that rapid count wave riding in a shallow, concrete environment can place on a surfboard. This invention has a complex but effective method of manufacture which provides a unique combination of advanced composite technology utilizing a purpose-molded and highly structural core, high impact-resistant fiber reinforcements, such as Innegra fibers with a strategic combination of fiberglass weights, patterns and weaves bonded with expanding epoxy foam which is then fused with a thermoformable plastic outer shell such as Acrylonitrile Butadiene Styrene (ABS) in a purpose built model specific vacuum closed mold which defines the final shape and forms a high impact protective layer. This process creates a surfboard which is superior to both existing traditional and non-traditional surfboards and is engineered using advanced processes and technology to provide a surfboard ideally suited to thrive in the unique demands of this environment. Owners of wave pools will benefit from using a surfboard which has the unique combination of high strength, reduced weight and high performance at a commercially attractive price for wave pool operators.

It should be noted that this method of manufacturing is also useful for creating surfboards for use outside of wave pools. If a surfboard is built to survive a wave pool environment, it makes sense that it will also outlive and out-perform a standard surfboard in a natural environment. In short, any surfer would benefit from a surfboard made using this technology to ride man-made or nature created waves.

In terms of the actual construction process, the surfboard begins as an EPS blank that has been molded to the approximate desired final shape. This presents a quick and easy way of creating a blank that is closer and with more structural integrity to the final shape than the traditional method of using a power planer to remove multiple layers from a larger blank to create a final shape. The molded blank is then cleaned and sanded to a final shape. To make the final surfboard strong enough to survive the rigors of a wave pool environment, a variety of strengthening materials, including a variety of advanced composite materials and several types of fiberglass, are laid down upon the top, bottom, and rails (sides) of the board, then attached to the blank with epoxy foam, which is them laminated with a spray gun. Special protection is given to the nose, tail, and rails (sides) of the surfboard, as these are the most commonly damaged parts in a wave pool environment. Fin boxes and a leash plug are installed, and then the surfboard is then fused to and the surface created by a pre thermoformed ABS sheet in a closed vacuum mold. The surfboard is then removed from the mold, trimmed, rail laminated, and sanded, then painted, pin lines are applied at the intersection of the top section and the rails, and then the surfboard is finished with a UV-stable clear coat.

One problem with using regular surfboards in a wave pool environment is that at the beach, the stresses on surfboards are often limited to wipeouts and occasional contact with rocks. Thus, regular surfboards are often constructed to be light weight, at the expense of strength. Wave pools, on the other hand, are constructed from cement sides and concrete walkways to access the waves. As such, the surfer in a wave pool has to deal with a much “harsher” environment for his/her surfboard than would a surfer at the average sandy beach. This has resulted in many surfers who bring their own “ocean surfboards” to wave pools ending up with damaged surfboards, and also creates a bad “goodwill” situation when a visiting surfer rents a surfboard at the wave pool, does not purchase the insurance on the board, and ends up damaging the board and having to pay for a costly repair. This situation creates a further problem for the wave pool operators, as they must keep an entire excess “fleet” of surfboards of different sizes and shapes, so that they have enough “ready” surfboards at any one time to handle their customer requests. The less time a surfboard spends in “ding repair”, the more time it is being rented and making money for the operator.

Thus, there has existed a need for an affordable, lightweight, high performance, solid and strong surfboard suitable for the unique stresses of the wave pool environment, as the prior art does not provide such a solution. The current invention meets this need by providing a wave pool surfboard with added protection in the most commonly damaged parts of the board, and manufactured by an efficient process that creates such a surfboard.

Different materials can be used to create a strong sandwich construction which is necessary to last in the environment of wave pools with its concrete floors and sidewalls. The current invention is created by a construction that utilizes a unique combination of advanced composite technology utilizing a purpose molded and highly structural core, high impact-resistant fiber reinforcements, with a strategic combination of fiberglass weights, patterns and weaves bonded with expanding epoxy foam which is then fused with a thermoformable plastic outer shell in a purpose-built model specific vacuum mold which defines the final shape and forms a high impact protective layer.

Description of the various materials used in construction.

Among the materials used in construction are:
Acrylonitrile Butadiene Styrene (ABS): Properties: High impact resistance, toughness, and good machinability.
Polycarbonate (PC): Properties: High impact resistance, transparency, and good thermal resistance.
Polyvinyl Chloride (PVC): Properties: Good chemical resistance, durability, and cost-effectiveness.
High Impact Polystyrene (HIPS): Properties: Good impact resistance, easy to mould, and inexpensive.
Polyethylene (PE): High-Density Polyethylene (HDPE): Properties: Lightweight, chemical resistance, and flexibility.
Polypropylene (PP): Properties: High fatigue resistance, chemical resistance, and good toughness.
Thermoplastic Polyurethane (TPU): Properties: Flexibility, abrasion resistance, and transparency.
Acrylonitrile Styrene Acrylate (ASA): Properties: UV, impact, chemical, thermal stability
Botane Sheet/Top Sheet: Properties: High impact resistance, toughness, and good machinability. Flexibility, abrasion resistance, and transparency.
Polyamide/Top Sheet: Properties: strength, toughness, thermal and chemical resistance

### High Impact Resistant Fibers

Innegra: Properties: lightweight, impact resistance, tensile strength
Basalt: Properties: great resistance due to their high strength-to-weight ratio and flexibility, resistant to abrasion and moisture,
Kevlar/Aramid/Twaron: Properties: high strength, hight impact resistance
S-Glass: Properties: high tensile strength, high temperature resistance
Ultra-High Molecular Weight Polyethylene (UHMWPE) Composites (Dyneema, Spectra): Properties: Extremely high impact strength, wear resistance
Zylon (p-phenylene-2,6-benzobisoxazole/PBO): Properties: exceptional tensile strength, thermal stability, high-impact resistant

The Key to the invention's superior impact resistance is the material combination:

Synergistic Impact Absorption: ABS provides good impact resistance and toughness on its own, but when reinforced with Innegra fibers, the composite can exhibit enhanced overall impact performance. This is very beneficial in applications such as wave pools where protection against impacts and shocks is crucial. Wave Pool sidewalls and bottoms are made by concrete.

Lightweight Design: Innegra fibers are lightweight and have a high strength-to-weight ratio. When combined with ABS, which is already a relatively lightweight thermoplastic, the composite structure can achieve weight savings compared to other materials. This is advantageous in applications where reducing weight without compromising strength is important, such as Surfboards especially build to be used in wave pools. Flexibility and Durability:

Improved Flexural Properties: ABS can be prone to cracking under certain conditions. Innegra fibers enhance the composite's flexibility and toughness, reducing the likelihood of cracking and improving durability. This makes the composite suitable for applications requiring resistance to repeated impacts or flexural stress. Furthermore, we coat our boards with a UV resistant top coat for further protection of the ABS, which brings this combination of materials to the next level.

There has thus been outlined, rather broadly, the more important features of the invention in order that the detailed description thereof may be better understood, and in order that the present contribution to the art may be better appreciated. There are additional features of the invention that will be described hereinafter, and which will form the subject matter of the claims appended hereto. The features listed herein, and other features, aspects and advantages of the present invention will become better understood with reference to the following description and appended claims. The accompanying drawings, which are incorporated in and constitute part of this specification, illustrate embodiments of the invention and, together with the description, serve to explain the principles of the invention.

It should be understood the while the preferred embodiments of the invention are described in some detail herein, the present disclosure is made by way of example only and that variations and changes thereto are possible without departing from the subject matter coming within the scope of the following claims, and a reasonable equivalency thereof, which claims I regard as my invention.

### BRIEF DESCRIPTION OF THE DRAWINGS

FIG. 1 is a top, partial cut-away view of the wave pool surfboard with various materials used in the manufacturing process and the location of the various materials on the surfboard.

FIG. 2 is a close-up, top perspective view of the various materials used in the wave pool surfboard.

FIG. 3 is a cross-sectional view of the materials applied to the rails (sides) of the wave pool surfboard.

FIG. 4 is a cross-sectional view of the wave pool surfboard showing the different materials and their order of placement.

### DETAILED DESCRIPTION OF PREFERRED EMBODIMENT

We first describe the process by which the wave pool surfboard is made, then we will turn to the individual figures showing the key elements. First, an ABS sheet is thermoformed at 60 degrees Celsius to the mold top/bottom for about 3 minutes. After it has been thermally molded to the desired end shape, it is removed and stored for later molding with “the mummy” described earlier.

Second, the production of the core begins with a rough surfboard “blank” that is molded by the manufacturer. By creating a molded blank that is very close in shape to the final desired shape, the process is streamlined significantly over the traditional method of obtaining a much larger blank made by another company, and then using saws and power planers to cut it down to the desired size and shape. The rough blank is then cleaned and sanded, and any fine-tuning of the shape is controlled with the use of templates, which are pre-set devices which guide a saw or planer to shave the blank to a desired final shape.

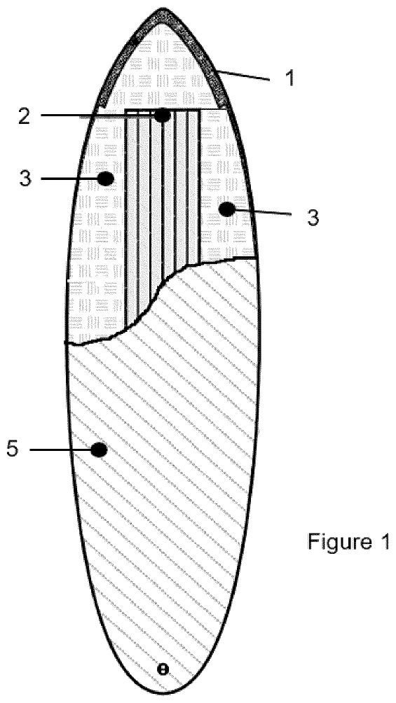

As a third step, various materials are attached and/or laminated to the wave pool surfboard in various locations. These materials include 200 gr fiberglass sheets, combination mat fiberglass mat, uni-directional fiberglass, Innegra 120 gr, ABS 0.4 mm, and EPS 20 gr. (The phrase “gr” for the cloth means gram per square meter, for the EPS it means gram per liter). The location of these materials is more fully illustrated in FIGS. 1, 2 and 3.

As a fourth step, a “mummy phase” of surfboard is created. Various types of protective materials are applied to different parts of the surfboard. The materials are cut into specific shapes with the use of templates. The various mats and sheets are applied separately to the core/EPS blank and to the mold surface. In the standard manufacturing process, the blank is wrapped in fiberglass and reinforcements are applied to the blank as well. The thermoformable ABS sheet is applied to the mold. The mummy is then inserted into the bottom mold, then the top part to close the mold. The mummy and all its components are then laminated together in a vacuum process. Before the lamination process, however, several different types of protective materials are applied.

In a fifth step, a deck stringer is applied. A deck stringer is a section of unidirectional fiberglass that gives the surfboard anti-flex support. In the earlier days of surfboard manufacturing, the stringer was a wood insert that was inserted between two halves of the blank. A fiberglass deck stringer, preferably made of 350 gr. unidirectional fiberglass, is applied on top of the blank, not requiring that the blank be cut in half for application. To “stick” the stringer to the deck of the surfboard, an epoxy foam is sprayed on with a spray gun.

In a sixth step, a 400 gr combination mat is applied to both the deck and bottom of the surfboard again with epoxy foam from a spray gun. Please note, the order of the 5th and 6th steps can be reversed.

In a seventh step, the process also includes the installation of nose and tail bumpers, or “reinforcement sections”, which protect the most vulnerable parts of the surfboard. These bumpers are small, extremely strong Innegra covers. These cover directly over the rail on nose and tail, but also nose/deck on nose and tail area that go over the tip portions of the nose and tail and are applied with Epoxy resin foam via spray/glue gun.

In an eighth step, the wave pool surfboard undergoes a “pressing process”. A full combination layer is applied to the bottom of the surfboard, then fin boxes are installed. The laminated core and fibers are then inserted to create a “sandwich” of the mummy, fibers and resin. The mold cover is than attached and the surfboard is vacuum molded for up to 4-5 hours, depending on board size and hardener used at a pressure of 65 cm Hg mercury.

In a ninth step, the molded surfboard is removed from the mold. The molded surfboard has an ABS molding seam left over from the molding process, which is then trimmed off with a power saw and power sander.

In a tenth step, the rails (the sides of the surfboard) are given an additional layer of protection for extra strength. After the board is molded, an additional fiberglass band is applied over the rails. Again, the goal is to provide extra support on the parts of the board that are most often damaged in wave pool environment.

In an eleventh step, the rails of the surfboard are “puttied” and then sanded. A rail band is applied first, then any gaps are filled in with putty. After the surfboard has been removed from the mold, there will be small indentations and irregularities at the intersection of the top and bottom panels that will become apparent after the ABS molding seam is trimmed off and the rails are laminated. A putty with is a combination of Epoxy Resin, Hardener and Carbosil (Micro Ballon/fumed silica) is applied to these irregularities and allowed to dry. After it dries, both rails of the surfboard are sanded to a desired smoothness.

In a twelfth step, the wave pool surfboard is painted on the deck, rails and bottom. All paints on these boards are PU based paints. It is very important that the clearcoat contains a UV stabilizer. Acrylic paints can be used as well. To allow for the rails to be colored a different color than the deck or bottom, masking tape is applied to “mask off” the rails, which are then painted a different color.

In a thirteenth step, the board undergoes a final customization and finishing process. Pinstripes are added at the intersection of two colors. These pinstripes, laid out with tape and filled with paint, cover up any irregularities where the two colors of paint meet. After pinstriping, a finishing clear coat is applied. This final coat is UV-stable to prevent “yellowing” of the board because of exposure to the sun.

FIGS. 1, 2, 3 and 4 refer to some materials used. These materials include 200 gr fiberglass sheets 3, combination mat fiberglass mat 32, uni-directional fiberglass 33, Innegra 120 gr 34, ABS 0.4 mm 35, and EPS 20 gr 36. The phrase “gr” for the cloth means gram per square meter, for the EPS it means gram per liter.

FIG. 1 is a top, partial cut-away view of the wave pool surfboard with various materials used in the manufacturing process and the location of the various materials on the surfboard. At the nose and tail sections, an Innegra nose bumper 1 and a tail bumper (not shown in this figure) are applied to protect the most vulnerable parts of the surfboard. These bumpers are small, extremely strong Innegra bumpers with a fiberglass cover. These cover directly over the rail on nose and tail, but also nose/deck on nose and tail area that go over the tip portions of the nose and tail and are applied with Epoxy resin foam via spray/glue gun. The EPS core blank has already been shaped down to its final shape, and is overlain with a UD Tape/Fiberglass piece 2 that goes directionally on the board to give it strength, and either before or after, a combination mat/fiberglass layer 3 is applied, all secured to the EPS core blank by a coat of epoxy resin 4. Finally, a thermoformed skin 5 is applied over the entire board through the vacuum or “mummy” process described earlier in this application. The resulting wave pool surfboard is both lightweight and strong, with particular strengthening features applied to the most sensitive/commonly damaged parts of the wave pool surfboard.

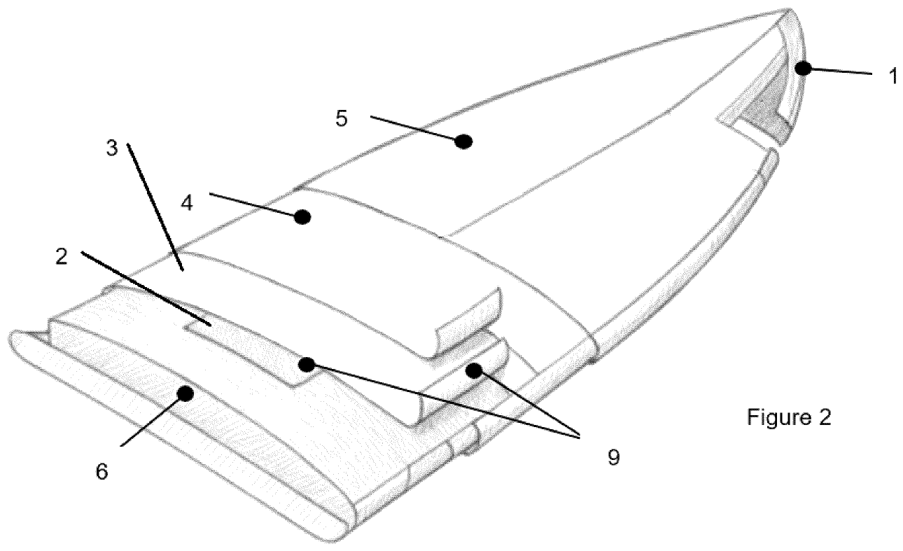

FIG. 2 is a close-up, top perspective view of the various materials used in the wave pool surfboard. The nose bumper 1 covers the nose and upper rails of the wave pool surfboard. The EPS core 6 is covered by a Tape/Fiberglass piece 2 that goes directionally on the board to give it strength, than a combination mat/fiberglass layer 3 (both designated by 9 as “fiberglass, generally”, all secured to the EPS core blank by a coat of epoxy resin 4. Finally, a thermoformed skin 5 is applied over the entire board through the vacuum or “mummy” process described earlier in this application.

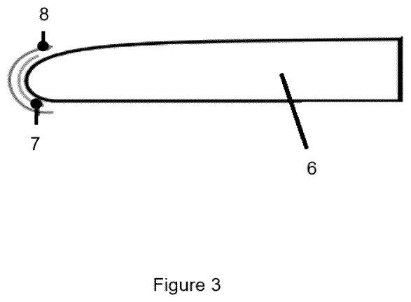

FIG. 3 is a cross-sectional view of the materials applied to the rails (sides) of the wave pool surfboard. A section of Rail Innegra 7 is applied, covered by a layer or Rail Fiberglass 8. While the nose and tail bumpers protect the nose and tail sections, the rail protectors protect the final part of the wave pool surfboard that is most commonly damaged.

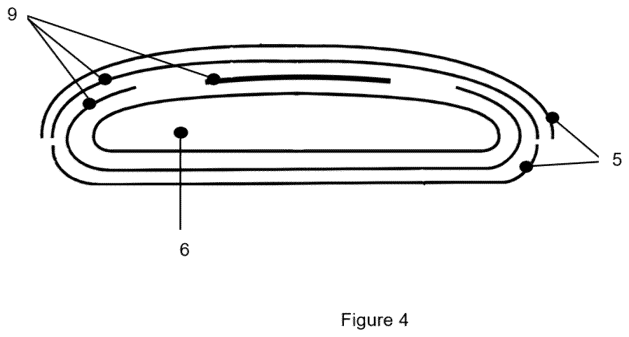

FIG. 4 is a cross-sectional view of the wave pool surfboard showing the different materials and their order of placement. The EPS core 6 is overlain with a UD Tape/Fiberglass piece 2 that goes directionally on the board to give it strength. This piece does not cover the entire deck, or upper portion of the surfboard, but rather just the middle section. This keeps the board's weight relatively light, while still giving it longitudinal strength. After the UD Tape/Fiberglass piece 2, a combination mat/fiberglass layer 3 is laid down over the UD Tape/Fiberglass piece 2, and a coat of epoxy resin 4 attaches both the UD Tape/Fiberglass piece 2 and the combination mat/fiberglass layer 3 to the EPS core 6. Finally, a thermoformed skin 5 is applied over the entire board through the vacuum or “mummy” process described earlier in this application.

In a preferred embodiment, the wave pool surfboard comprises a blank, where the blank comprises an EPS core, a shaping process, application of a strengthening shell comprising a nose reinforcement, a tail reinforcement, and a rail reinforcement, a fiberglass component, and application of the strengthening shell with epoxy foam applied with a spray gun. In this preferred embodiment, the blank is prepared with an ABS sheet that is thermoformed at 60 degrees Celsius to a mold top and a mold bottom for about 3 minutes, and after the blank has been thermally molded to the desired end shape. The EPS core blank is then modified to a final blank shape by being cleaned and sanded, and then fine-tuned with the use of one or more templates.

After the blank has been created and shaped to the final shape, the strengthening phase begins. The strengthening materials include one or more 200 gr fiberglass sheets, one or more combination mat fiberglass mats, one or more layers of uni-directional fiberglass, one or more pieces Innegra 120 gr, one or more ABS 0.4 mm, and one or more EPS 20 gr, where the phrase “gr” for the cloth means gram per square meter and for the EPS it means gram per liter. These various materials are applied at different parts of the wave pool surfboard to strengthen it in various ways. These strengthening materials are cut into specific shapes with the use of templates and applied separately to the core/EPS blank and to the mold surface.

In one preferred embodiment, a “mummy” is then inserted into a bottom mold, then a top part is closed to seal the mold, where the mummy and all its components are then laminated together and covered with a thermoformed skin, in a vacuum process, and additionally comprising the steps of removing the surfboard from the mold and trimming off an ABS molding seam with a power saw and power sander, additionally comprising a step of applying a rail band of Rail Innegra and a layer of layer fiberglass to the rails, additionally comprising a step of the rails being given a putty, and then having the putty sanded, where, the putty is a combination of Epoxy Resin, Hardener and Carbosil (Micro Ballon/fumed silica, additionally comprising a step of painting with PU paint, making off the rails for the rails to be painted a different color, with a pinstriping and a final UV-stable coat to prevent “yellowing” of the board because of exposure to the sun.

In another preferred embodiment, more work is done to the wave pool surfboard before the mummy phase. For example, a nose bumper and a tail bumper are installed, where the nose bumper and the tail bumper are made from extremely strong Innegra covers. Additional protection is provided by a deck stringer or UD Tape/Fiberglass, where the deck stringer is applied to a top of the blank, where the deck stringer is a section of unidirectional fiberglass that gives the surfboard anti-flex support. In one preferred embodiment, the fiberglass deck stringer is made of 350 gr. unidirectional fiberglass, applied on top of the blank, where the stringer is “stuck” to the deck of the surfboard by an epoxy foam is sprayed on with a spray gun. Over the stringer is a 400 gr combination mat, which is applied to both the deck and bottom of the surfboard with epoxy foam from a spray gun. In addition, nose and tail reinforcement sections, called “bumpers” with layers of Innegra and fiberglass are applied with Epoxy resin foam via spray/glue gun. After application of the various strengthening materials, a “mummy” phase occurs, where a thermoformed skin is applied over the wave pool surfboard. This thermoformed skin is created through a pressing process, where a full combination layer is applied to the bottom of the surfboard, then fin boxes are installed, the laminated core and fibers are then inserted to create a “sandwich” of the mummy, fibers and resin, after which the mold cover is than attached and the surfboard is vacuum molded for up to 4-5 hours, depending on board size and hardener used at a pressure of 65 cm Hg mercury.

After the “mummy” phase, the surfboard is removed from the mold. Because of the pressing process, there is an ABS molding seam that needs to be removed with a power saw and power sander. After the ABS molding seam is removed, the rails (the last part of the wave pool surfboard that is often damaged, after the nose and the tail) are protected by applying a rail band of Rail Innegra and a layer of layer fiberglass to the rails. The rails are the in “puttieď”, which given a putty to fill in the holes/depressions/irregularities in the rails, and then sanded to create a smooth rail. The putty is a combination of Epoxy Resin, Hardener and Carbosil (Micro Ballon/fumed silica).

Once the rails are smooth, there is a final step of “finishing” the wave pool surfboard. First, it is painted with PU paint, making off the rails for the rails to be painted a different color, with a pinstriping and a final UV-stable coat to prevent “yellowing” of the board because of exposure to the sun.

Each of the figures and methods disclosed herein can be used separately, or in conjunction with other features and methods, to provide improved devices and methods for making and using the same. Therefore, combinations of features and methods disclosed herein may not be necessary to practice the disclosure in its broadest sense and are instead disclosed merely to particularly describe representative and preferred embodiments.

Various modifications to the embodiments may be apparent to one of skill in the art upon reading this disclosure. For example, persons of ordinary skill in the relevant arts will recognize that the various features described for the different embodiments can be suitably combined, un-combined, and re-combined with other features, alone, or in different combinations. Likewise, the various features described above should all be regarded as example embodiments, rather than limitations to the scope or spirit of the disclosure.

Persons of ordinary skill in the relevant arts will recognize that various embodiments can comprise fewer features than illustrated in any individual embodiment described above. The embodiments described herein are not meant to be an exhaustive presentation of the ways in which the various features may be combined. Accordingly, the embodiments are not mutually exclusive combinations of features; rather, the claims can comprise a combination of different individual features selected from different individual embodiments, as understood by persons of ordinary skill in the art.

Any incorporation by reference of documents above is limited such that no subject matter is incorporated that is contrary to the explicit disclosure herein. Any incorporation by reference of documents above is further limited such that no claims included in the documents are incorporated by reference herein. Any incorporation by reference of documents above is yet further limited such that any definitions provided in the documents are not incorporated by reference herein unless expressly included herein.

Unless indicated otherwise, references to “embodiment(s)”, “disclosure”, “present disclosure”, “embodiment(s) of the disclosure”, “disclosed embodiment(s)”, and the like contained herein refer to the specification (text, including the claims, and figures) of this patent application that are not admitted prior art.

For purposes of interpreting the claims, it is expressly intended that the provisions of 35 U.S.C. 112(f) are not to be invoked unless the specific terms “means for” or “step for” are recited in the respective claim.

It should be understood that while the preferred embodiments of the invention are described in some detail herein, the present disclosure is made by way of example only and that variations and changes thereto are possible without departing from the subject matter coming within the scope of the following claims, and a reasonable equivalency thereof, which claims I regard as my invention.

All of the material in this patent document is subject to copyright protection under the copyright laws of the United States and other countries. The copyright owner has no objection to the facsimile reproduction by anyone of the patent document or the patent disclosure, as it appears in official governmental records but, otherwise, all other copyright rights whatsoever are reserved.

### Glossary of Terms

1. Nose bumper (Innegra/fiberglass)
2. UD Tape/Fiberglass
3. Combination Mat/Fiberglass
4. Epoxy Resin
5. Thermoformed skin
6. EPS Core blank.
7. Rail Innegra
8. Rail Fiberglass
9. Fiberglass, generally

What I claim is:

1. A wave pool surfboard specifically designed for a wave pool, comprising: a blank, where the blank is a core/EPS blank, a shaping process, application of a strengthening shell comprising a nose reinforcement, a tail reinforcement, and a rail reinforcement, a fiberglass component, and application of the strengthening shell with epoxy foam applied with a spray gun.

2. The wave pool surfboard of claim 1, where the blank is prepared with an ABS sheet that is thermoformed at 60 degrees Celsius to a mold top and a mold bottom for about 3 minutes.

3. The wave pool surfboard of claim 2, where after the blank has been thermally molded to the desired end shape, it is removed and stored for later molding with “a mummy”.

4. The wave pool surfboard of claim 3, where the blank is modified to a final blank shape by being cleaned and sanded, and then fine-tuned with the use of one or more templates.

5. The wave pool surfboard of claim 4, where the strengthening shell includes one or more 200 gr fiberglass sheets, one or more combination mat fiberglass mats, one or more layers of uni-directional fiberglass, one or more pieces Innegra 120 gr, one or more ABS 0.4 mm, and one or more EPS 20 gr, where the phrase “gr” for the cloth means gram per square meter and for the EPS it means gram per liter.

6. The wave pool surfboard of claim 5, where a strengthening phase occurs where one or more types of protective materials are applied at different parts of the surfboard.

7. The wave pool surfboard of claim 6, where the one or more types of materials are cut into specific shapes with the use of templates and applied separately to the core/EPS blank and to the mold surface, and one or more fin boxes are inserted into the core/EPS blank.

8. The wave pool surfboard of claim 7, where the mummy is then inserted into a bottom mold, then a top part is closed to seal the mold.

9. The wave pool surfboard of claim 8, where the mummy and all its components are then laminated together and covered with a thermoformed skin, in a vacuum process, and additionally comprising the steps of removing the surfboard from the mold and trimming off an ABS molding seam with a power saw and power sander, additionally comprising a step of applying a rail band of Rail Innegra and a layer of layer fiberglass to the rails, additionally comprising a step of the rails being given a putty, and then having the putty sanded, where, the putty is a combination of Epoxy Resin, Hardener and Carbosil (wherein Carbosil is a combination of Micro Ballon/fumed silica), additionally comprising a step of painting with PU paint, making off the rails for the rails to be painted a different color, with a pinstriping and a final UV-stable coat to prevent “yellowing” of the board because of exposure to the sun.

10. The wave pool surfboard of claim 7 where a nose bumper and a tail bumper are installed, where the nose bumper and the tail bumper are made from extremely strong Innegra covers.

11. The wave pool surfboard of claim 10, where the application process additionally comprises a deck stringer, where the deck stringer is applied to a top of the blank, where the deck stringer is a section of unidirectional fiberglass that gives the surfboard anti-flex support.

12. The wave pool surfboard of claim 11, where the fiberglass deck stringer is made of 350 gr. unidirectional fiberglass, applied on top of the blank, where the stringer is “stuck” to the deck of the surfboard by an epoxy foam is sprayed on with a spray gun.

13. The wave pool surfboard of claim 12, additionally comprising the application of a 400 gr combination mat applied to both the deck and bottom of the core/EPS blank with epoxy foam from a spray gun.

14. The wave pool surfboard of claim 13, additionally comprising the application of a nose and a tail reinforcement sections, applied with Epoxy resin foam via spray/glue gun.

15. The wave pool surfboard of claim 14, additionally comprising the application of a combination mat to the bottom of the core/EPS blank.

16. The wave pool surfboard of claim 15, additionally comprising a thermoformed skin, which is created through a pressing process, where a full combination layer is applied to the bottom of the core/EPS blank, then fin boxes are installed, the laminated core and fibers are then inserted to create a “sandwich” of the mummy, fibers and resin, after which the mold cover is than attached and the surfboard is vacuum molded for up to 4-5 hours, depending on board size and hardener used at a pressure of 65 cm Hg mercury.

17. The wave pool surfboard of claim 16 additionally comprising the steps of removing the surfboard from the mold and trimming off an ABS molding seam with a power saw and power sander.

18. The wave pool surfboard of claim 17, additionally comprising a step of applying a rail band of Rail Innegra and a layer of layer fiberglass to the rails.

19. The wave pool surfboard of claim 18, additionally comprising a step of the rails being given a putty, and then having the putty sanded, where, the putty is a combination of Epoxy Resin, Hardener and Carbosil (Micro Ballon/fumed silica.

20. The wave pool surfboard of claim 19, additionally comprising a step of painting with PU paint, making of the rails for the rails to be painted a different color, with a pinstriping and a final UV-stable coat to prevent “yellowing” of the board because of exposure to the sun.
